(19) United States
(12) Patent Application Publication
(10) Pub. No.: US 2021/0162991 A1
(43) Pub. Date: Jun. 3, 2021

(54) METHOD AND DRIVER ASSISTANCE SYSTEM FOR AVOIDING A COLLISION OF A VEHICLE WITH AN OBSTACLE

(71) Applicant: Robert Bosch GmbH, Stuttgart (DE)

(72) Inventors: Jianda Wang, Yokohama-Shi, Kanagawa (JP); Juergen Schmidt, Magstadt (DE); Tom Reimann, Bissingen An Der Teck (DE); Werner Urban, Vaihingen/Enz (DE)

(73) Assignee: Robert Bosch GmbH, Stuttgart (DE)

(21) Appl. No.: 17/048,034

(22) PCT Filed: Jun. 13, 2019
(86) PCT No.: PCT/EP2019/065533

§ 371 Date: Oct. 15, 2020

(30) Foreign Application Priority Data
Jun. 20, 2018 (DE) 102018209959.6

(51) Int. Cl. B60W 30/09; G08G 1/16; G01S 15/931

(52) U.S. Cl. CPC B60W 30/09; G08G 1/16; G01S 15/931; B60W 2554/801; B60W 2530/201; B60W 2552/30; B60W 2420/54; B60W 2520/06; B60W 2554/802

(57) ABSTRACT

A method for avoiding a collision of a vehicle with an obstacle, using at least one ultrasonic sensor. Reflection points are determined during a movement of the vehicle, the reflection points representing locations at which a signal of an ultrasonic sensor was reflected. The reflection points are combined into contiguous, linearly extending wall sections, a wall section having two ends. Furthermore, it is determined whether an end of a wall section is open or closed. The progression abutting an open end of a wall section is extrapolated, and virtual collision points between the vehicle and the extrapolated progression of the wall sections are ascertained. An initiation of a brake intervention follows if a collision with a virtual collision point is imminent. A driver assistance system including at least one ultrasonic sensor configured to carry out the method, and a vehicle including such a driver assistance system, are also described.

### FIELD

The present invention relates to a method for avoiding a collision of a vehicle with an obstacle, a distance between the vehicle and an obstacle in the surroundings of the vehicle being determined with the aid of at least one ultrasonic sensor in that the at least one ultrasonic sensor emits signals and receives back echoes of the signal reflected at the obstacle. The present invention furthermore relates to a driver assistance system for avoiding a collision of a vehicle which includes at least one ultrasonic sensor for determining a distance between the vehicle and an obstacle in the surroundings of the vehicle and is designed to carry out the method.

### BACKGROUND INFORMATION

A variety of driver assistance systems are used in the automotive field, which are intended to assist the driver with carrying out various driving maneuvers. These include, for example, parking assistance systems which, with the aid of the sensors assigned to the vehicle, detect the surroundings, ascertain possible parking spaces in the surroundings, and support the driver during parking. Other driver assistance systems warn the driver, for example, against objects situated in the blind spot. Some driver assistance systems include a brake function, which decelerates the vehicle before a collision occurs.

A method for warning a driver of a motor vehicle against the presence of an object in the surroundings is described in German Patent Application No. DE 10 2014 111 951 A1. In the method, a minimum distance between the motor vehicle and an object is continuously ascertained, a warning being output when a drop below a predetermined threshold value occurs. In addition, a collision distance is continuously ascertained, which describes a distance between the motor vehicle and the object when the motor vehicle is moving within the ascertained driving path.

A method for warning a driver of a motor vehicle against a collision risk is described in German Patent Application No. DE 10 2013 021 827 A1. In the method, objects, which are situated in a warning range outside the driving path, are used, in addition to objects in the driving path of the vehicle. For example, a warning range in the area of the front left corner of the motor vehicle may be defined when backing up. In this way, for example, a collision with an elongated object which is situated to the left of the vehicle may be avoided, whose portions protruding into the driving path, however, are situated outside the visual ranges of the sensors of the motor vehicle.

The disadvantage of the related art is that a collision with objects protruding into the driving path of a vehicle is often only detected at a very late stage, so that an avoidance of a collision by braking is often no longer possible.

### SUMMARY

A method for avoiding a collision of a vehicle with an obstacle is provided, a distance between the vehicle and an obstacle in the surroundings of the vehicle being determined with the aid of at least one ultrasonic sensor in that the at least one ultrasonic sensor emits signals and receives back echoes of the signal reflected at the obstacle.

In accordance with an example embodiment of the present invention, it is provided in the method that reflection points are determined during a movement of the vehicle in a step a) of the method, the reflection points representing locations at which a signal of an ultrasonic sensor was reflected. In a subsequent step b) of the method, the determined reflection points are assigned to objects. In the process, in particular, reflection points are combined into contiguous, linearly extending wall sections, a wall section having two ends.

In a subsequent step c) of the method, it is determined whether an end of a wall section is open or closed. An end of a wall section is considered to be closed when the reflection points abutting the respective end follow a non-linear progression or when, during further movement of the vehicle, no further reflection points are combined with the respective end of a wall section. Otherwise, an end of a wall section is considered to be open.

In accordance with an example embodiment of the present invention, in a subsequent step d) of the method, the progression which follows an open end is extrapolated for wall objects which have at least one open end. In a subsequent step e) of the method, virtual collision points between the vehicle and the extrapolated progression of the wall sections are ascertained. In a subsequent step f) of the method, a brake intervention is initiated if a collision of the vehicle with a virtual collision point is imminent.

In accordance with an example embodiment of the present invention, for the determination of the reflection points according to step a) of the method, for example, signals are emitted by an ultrasonic sensor, and ultrasonic echoes reflected by objects of the surroundings are received back by this sensor. In the process, the distance of the object from the vehicle is determined for each received ultrasonic echo based on the propagation time between the emission of the signal and the reception of the echo. Furthermore, in addition to the ascertained distance or distance value, a point in time is assigned and/or a reference to a route traveled by the vehicle is assigned to the ascertained distance for the formation of reflection points. In this way, a progression of reflection points may be generated, in which a dependence between a measured distance and the time at which the distance was measured and/or a dependence with respect to the route traveled by the vehicle is established.

When at least two ultrasonic sensors are used, whose visual ranges within which they are able to discern echoes of objects overlap at least partially, it is not only possible to ascertain the distance between the vehicle and the reflecting object, but it is also possible to determine the relative position of the object or of the reflection point with respect to the vehicle, with the aid of a measurement of the distance from an object by both ultrasonic sensors and subsequent lateration. In this case, it is preferred to assign to the reflection point the time, at which the echo was received as well as the position of the reflection point with respect to the vehicle, for forming the progression of reflection points.

In accordance with an example embodiment of the present invention, in step b) of the method, the ascertained reflection points are combined into objects. For this purpose, the progression of the reflection points may be analyzed, for example using a tracking filter, reflection points situated closely together being combined into an object. For the combination of the reflection points, it may be provided, for example, to create a virtual surroundings map. A location is entered for each reflection point in this surroundings map. In the process, in particular, the distance or the position with respect to the vehicle recorded for the given reflection points, as well as the respective vehicle position at the point in time of the measurement, are used for creating the surroundings map.

In the example method, it is, in particular, provided to combine the reflection points into contiguous, linearly extending wall sections. When using a tracking filter which combines reflection points, or locations representing them, into objects, objects which have an elongated shape or in which the combined reflection points are situated in a line are considered to be such a wall section. Each wall section has a first end and a second end. A wall section includes at least three reflection points, a wall section preferably has at least four, and particularly preferably at least five, reflection points.

The ascertained wall sections in each case belong to an obstacle or an object in the surroundings of the vehicle, a wall section always representing a linearly extending portion of a contour of this object. The object may be an elongated object, such as a guard rail, a wall or a hedge. Or it may be a portion of the contour of an object which is linear. For example, the contours of vehicles include sections which appear in a linear and elongated manner when they are scanned by ultrasonic sensors. The object or obstacle is preferably stationary. However, the method may be applied to dynamic, i.e., moving objects.

In accordance with an example embodiment of the present invention, during the further course of the method, a distinction is made between open and closed ends of wall sections. In the case of closed ends of a wall section, the end of the wall or of the object was already detected, and a further extension of the object in this direction is not possible. In the case of open ends of a wall section, initially only a portion of the wall or of the object was seen, and the entire extension of this object or of the wall is not yet known. For the distinction between an open and a closed end, it is determined whether the reflection points following or abutting the particular end follow a non-linear progression in the area of the end of the wall section. Such a non-linear progression indicates that an end of the linearly extending wall section of the object was reached, and the contour of this object has a bend. In particular, a non-linear progression representing a bent curve, which is curved away from a movement direction of the vehicle, indicates such an edge of an object, which represents an end of the linear wall section.

Such a non-linear progression cannot be observed in some circumstances in the case of elongated objects such as guard rails, walls or hedges. In such a case, it is instead established that no further reflection points, which could be combined with the particular end of the wall section, are ascertained any longer, even with further movement of the vehicle along its driving direction.

In all other instances, it is assumed that the particular end of the wall section is open.

In accordance with an example embodiment of the present invention, if a wall section has an open end, it is now ascertained in the method whether a collision between the vehicle and one of the wall sections is imminent. For this purpose, the open ends of the wall sections are extended with the aid of extrapolation, and virtual collision points between these extended wall sections and a driving path which represents the presumable movement of the vehicle are checked. The driving path is represented by two lines extending in parallel to one another, which delimit the area presumably negotiated by the vehicle, provided the present speed and direction are maintained. The driving path is dependent on the speed, the view angle, and the dimensions of the vehicle. When one of the extrapolated ends of a wall section intersects a line delimiting the driving path, a virtual collision point is generated at this intersecting point.

If a virtual collision point was ascertained, a brake intervention is initiated if a collision with the virtual collision point is imminent. A collision is imminent, in particular, when a distance between the virtual collision point and the vehicle is below a warning distance. This warning distance may vary as a function of the speed of the vehicle and is preferably selected in such a way that, even with a small delay of the vehicle during a brake intervention, a deceleration of the vehicle is ensured prior to reaching the virtual collision point.

Of course, it is also possible to define other conditions for the initiation of a brake intervention, in addition to the virtual collision points. It is preferably provided, for example, upon the identification of a reflection point situated in the driving path, and thus a direct knowledge of an obstacle in the driving path, to initiate a brake intervention

In the brake intervention according to step f), it is preferably provided to initiate an emergency brake application with maximum deceleration when this is necessary to avoid this collision with a virtual collision point, or to reduce damage which would occur in the event of a collision. If no emergency brake application is necessary yet, it is preferred to carry out a comfortable deceleration of the vehicle when a brake intervention is initiated, with a delay which is smaller than the maximum deceleration of the vehicle. As a result of such a delay which is smaller than the maximum possible deceleration of the vehicle, a particularly comfortable deceleration is achieved, the distance already being reduced up to the point at which an emergency brake application absolutely has to be initiated, and thereby more time being created to find a potential closed end of the wall section.

The delay selected for the comfortable deceleration is preferably selected in such a way that the vehicle is decelerated up to a standstill just prior to reaching the virtual collision point.

In the example method, it is preferably provided to continue to observe the surroundings of the vehicle even after the initiation of the brake intervention, to determine reflection points, and to combine them into wall sections. It is possible in the process that the end is identified for a wall section which previously had an open end, and thereby now a closed end is present. In such a case, a previously ascertained virtual collision point is dispensed with, if necessary. Furthermore, the virtual collision points are, in particular, recalculated when a steering motion of the vehicle has taken place, whereby collision points may be dispensed with, if necessary, and new collision points may arise.

An initiated comfortable deceleration is preferably terminated, and thus an actuated brake is released again, when the virtual collision point responsible for the deceleration of the vehicle has been dispensed with.

The example method, with its steps a) through f), is preferably repeatedly run through during a movement of the vehicle, so that a continuous monitoring of the surroundings takes place; if necessary, new collision points are ascertained, and, if necessary, already ascertained virtual collision points are dispensed with again.

Another aspect of the present invention is to provide a driver assistance system for avoiding a collision of a vehicle with an obstacle. In accordance with an example embodiment of the present invention, the driver assistance system includes at least one ultrasonic sensor for determining a distance between the vehicle and an obstacle in the surroundings of the vehicle, and is designed to carry out one of the methods described herein.

The driver assistance system preferably includes a control unit, which is connected to the at least one ultrasonic sensor and has a connection to a braking system of a vehicle. The control unit preferably implements one of the methods described herein.

In one preferred specific embodiment, the driver assistance system includes multiple ultrasonic sensors, particularly preferably at least two ultrasonic sensors being situated in such a way that their visual ranges, within which they are able to discern objects in the surroundings of the vehicle, overlap at least partially. In this overlapping area, it is not only possible to ascertain a distance between the object and the vehicle, using the two ultrasonic sensors, but it is also possible to determine the position of this object, or of the reflection point on this object, with respect to the vehicle, using the lateration.

The present invention furthermore relates to a vehicle which includes one of the driver assistance systems described here.

With the aid of the provided method, a possible collision of a vehicle with an object may already be ascertained in many instances, even though the sensors of the vehicle have not yet identified an obstacle protruding into the driving path of the vehicle. This early identification of a possible collision is preferably used to initially decelerate the vehicle gently and comfortably for the passengers, since the deceleration may already be started at an early stage due to the early identification of an impending collision. A full brake application or an emergency brake application is only required when the distance from the obstacle is decreasing more quickly than initially expected, for example due to an incorrect steering motion of the driver.

Furthermore, advantageously an initially gently and comfortably initiated brake intervention may also be terminated again if it should turn out, for example, that, as a result of the identification of an end of a wall section, no collision at all is impending or an impending collision is avoided by a suitable steering motion of the driver.

### BRIEF DESCRIPTION OF THE DRAWINGS

FIG. 1 shows the parallel passing of a stationary obstacle.

FIG. 2 shows an impending collision with a stationary obstacle.

### DETAILED DESCRIPTION OF EXAMPLE EMBODIMENTS

In the following description of the exemplary embodiments of the present invention, identical elements are denoted by the same reference numerals, a repeated description of these elements in individual cases being dispensed with. The figures only schematically represent the subject matter of the present invention.

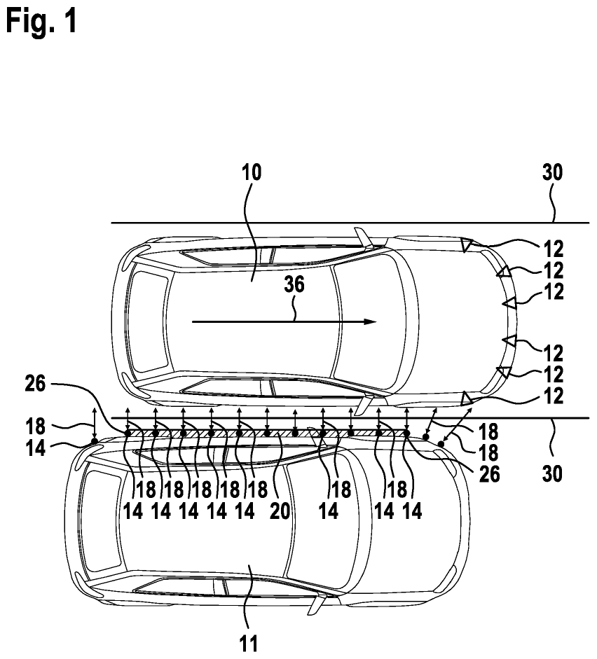

FIG. 1 shows a vehicle 10 including a driver assistance system according to an example embodiment of the present invention, which is moving along the direction marked by reference numeral 36. Based on movement direction 36, the speed and the dimensions of vehicle 10, a driving path is determined, which is delimited by two boundary lines 30.

In the exemplary embodiment shown in FIG. 1, vehicle 10 has six ultrasonic sensors 12 for monitoring the surroundings of vehicle 10. For this purpose, ultrasonic sensors 12 each emit ultrasonic pulses and receive ultrasonic echoes reflected at objects. In FIG. 1, an obstacle 11 is represented in the form of a stationary vehicle. This obstacle 11 represents an object which reflects signals emitted by ultrasonic sensors 12. For each reflected echo, a distance 18 is determined by vehicle 10 or by the driver assistance system assigned to vehicle 10. If the fields of vision in which ultrasonic sensors 12 are able to detect objects at least partially overlap, it is also possible, with the aid of lateration, to determine the exact position of the point reflecting the ultrasound with respect to vehicle 10. For this purpose, distances 18 measured by the two involved ultrasonic sensors 12 as well as the known distance between the two ultrasonic sensors 12 are required.

Based on the ascertained sensor data of ultrasonic sensors 12, a surroundings map is created, in which reflection points 14 are entered, which each represent the location at which the respective ultrasonic signal was reflected by obstacle 11. If an exact position determination of a reflection point 14 is not possible, for example because only a single ultrasonic sensor 12 has received a corresponding echo, a progression of reflection points 14 may be created, in which the ascertained distances 18 are plotted as a function of the measuring point in time and/or the route traveled by vehicle 10.

Based on the progression or based on the created surroundings map, reflection points 14 are now combined into objects, reflection points 14, in particular, being combined into contiguous, linearly extending wall sections 20. In the process, reflection points 14 situated closely together are combined into a wall section 20 in the surroundings map or in the progression. Two reflection points 14 may be considered to be situated closely together when a distance between the two reflection points 14 is below a predefined limiting value.

The contiguous, linearly extending wall sections 20 arising as a result of the combination of reflection points 14 have two ends. In the example illustrated in FIG. 1, both ends are closed ends 26 since reflection points 14 following closed end 26 in each case do not continue to follow the straight, linear progression of the remaining reflection points 14 of wall section 20, but move further away from vehicle 10.

Since both ends of wall section 20 are closed, no extrapolation of the further progression of wall sections 20 takes place. Since the two boundary lines 30 which delimit the driving path of vehicle 10 also do not intersect wall section 20, no collision point may be ascertained. No collision is imminent between vehicle 10 and obstacle 11.

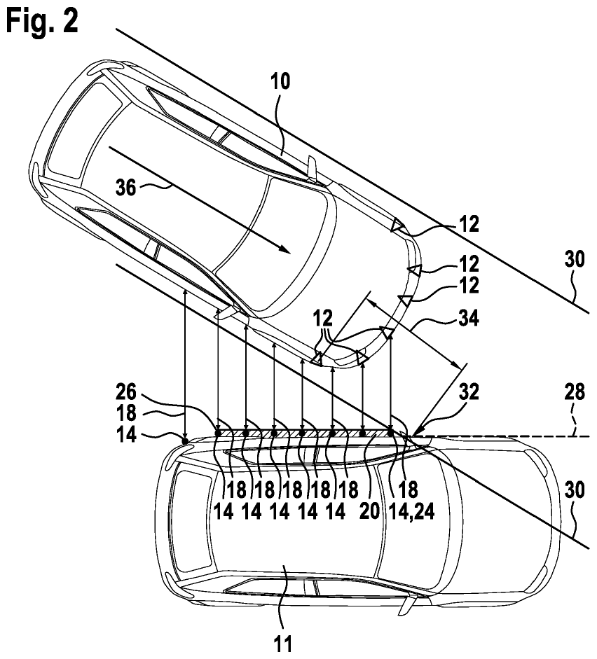

FIG. 2 shows a similar situation as FIG. 1. Vehicle 10 is moving along the direction marked by reference numeral 36, the driving path of vehicle 10 again being delimited by the two boundary lines 30. In contrast to the situation shown in FIG. 1, vehicle 10 is no longer moving in parallel to obstacle 11, but is moving at an angle thereto.

During the movement of vehicle 10, signals are continuously emitted by ultrasonic sensors 12, and echoes are received back, in each case a distance 18 being again assigned to an echo, and reflection points 14 being determined.

As may be derived from the representation in FIG. 2, the ascertained reflection points 14 were combined into a wall section 20, which has a closed end 26. The closed end 26 is again characterized in that distance 18 of reflection point 14 following closed end 26 with respect to vehicle 10 has increased, so that the position of reflection point 14, which abuts closed end 26, does not follow a linear progression. Reflection point 14 abutting closed end 26 is not situated on a straight line extending through reflection points 14 which were assigned to wall section 20.

The other end of wall section 20 is an open end 24 since all previously ascertained reflection points 14 are situated in the vicinity of open end 24 on the straight line which is defined by all reflection points 14 of wall section 20. As a result, an extrapolation is carried out, the further progression of wall section 20 being estimated by an extrapolated straight line 28. Extrapolated straight line 28 intersects one of boundary lines 30 delimiting the driving path of vehicle 10 in the representation of FIG. 2. A virtual collision point 32 arises at the intersecting point. The distance between vehicle 10 and virtual collision point 32 is denoted by reference numeral 34.

A brake intervention takes place based on the identification of the virtual collision point 32, vehicle 10 preferably being decelerated gently and comfortably. For the comfortable deceleration, the delay is selected in such a way that vehicle 10 comes to a halt just before virtual collision point 32. In the event that the driver of vehicle 10 changes movement direction 36 of vehicle 10 by a steering motion in such a way that virtual collision point 32 is dispensed with, the brake intervention is terminated so that the driving operation of vehicle 10 may be continued without interruption.

Virtual collision point 32 is advantageously already identified before a reflection point 14, which is situated within the driving path of vehicle 10, has been ascertained using ultrasonic sensors 12. Due to this early identification of virtual collision points 32, a brake intervention may be commenced at an earlier stage, and thus a deceleration may take place with a smaller, comfortable delay.

If the angle between vehicle 10 and obstacle 11 were flatter, so that virtual collision point 32 is situated further away and outside obstacle 11, vehicle 10 would continue to determine reflection points 14 during the comfortable braking, using its ultrasonic sensors 12, and continue to combine them into wall sections 20. If the end of obstacle 11 were reached during the further course, a non-linear progression of reflection points 14 with respect to a straight line would be ascertained, which extends through reflection points 14 assigned to wall section 20. This would then be interpreted as closed end 26 of wall section 20, so that no determination of an extrapolated straight line 28 takes place, and thus also virtual collision point 32 would be dispensed with. This means that in such a case vehicle 10 would initially decelerate carefully until ultrasonic sensors 12 have identified the end of wall section 20 as closed, and thus have identified the end of obstacle 11. Since an impending collision may then be excluded, vehicle 10 would, in this case, continue its driving operation unimpeded, and the comfortable brake application would be terminated.

The present invention is not limited to the exemplary embodiments described here and the aspects highlighted therein. Rather, a plurality of modifications is possible within the scope of the present invention, which are within the capabilities of those skilled in the art.

1-10. (canceled)

11. A method for avoiding a collision of a vehicle with an obstacle, a distance between the vehicle and an obstacle in surroundings of the vehicle being determined using at least one ultrasonic sensor in that the at least one ultrasonic sensor emits signals and receives back echoes of the signal reflected at the obstacle, the method comprising the following steps:
a) determining reflection points during a movement of the vehicle, the reflection points representing locations at which a signal of the ultrasonic sensor was reflected;
b) combining the reflection points into contiguous, linearly extending wall sections, wherein each of the wall sections have two ends;
c) determining whether an end of each of the wall sections is open or closed, the end of each wall section being considered to be closed when the reflection points abutting the end follow a non-linear progression, or when, during further movement of the vehicle, no further reflection points are combined with the end of the wall section, and the end otherwise being considered to be open;
d) extrapolating a progression of each the wall sections following each open end;
e) ascertaining virtual collision points between the vehicle and the extrapolated progressions of the wall sections; and
f) initiating a brake intervention based on a collision with at least one of the virtual collision points being imminent.

12. The method as recited in claim 11, wherein an emergency brake application with maximum deceleration is initiated in step f), when it is necessary to avoid a collision with that at least one of the virtual collision points, or to reduce damage, and when no emergency brake application is necessary yet, initiating a comfortable deceleration of the vehicle using a delay which is smaller than the maximum deceleration of the vehicle.

13. The method as recited in claim 12, wherein the delay for the comfortable braking is selected in such a way that the vehicle is decelerated up to a standstill prior to reaching the at one of the virtual collision points.

14. The method as recited in claim 12, wherein the comfortable deceleration is terminated, and a brake is released again, when the at least one of the virtual collision points responsible for the delay has been dispensed with.

15. The method as recited in claim 11, wherein the non-linear progression according to step c) is a bent curve, which is curved away from a movement direction of the vehicle.

16. The method as recited in claim 11, wherein each of the virtual collision points is present as an intersecting point of a straight line given by the extrapolation of one of the wall sections with a boundary line of a driving path of the vehicle.

17. The method as recited in claim 16, wherein the driving path is present due to an instantaneous driving direction of the vehicle, an instantaneous steering angle of the vehicle, and dimensions of the vehicle.

18. The method as recited in claim 11, wherein steps a) through f) are repeatedly run through during the movement of the vehicle.

19. A driver assistance system for avoiding a collision of a vehicle with an obstacle, the driver assistance system comprising:
at least one ultrasonic sensor for determining a distance between the vehicle and an obstacle in surroundings of vehicle;
wherein the driver assistance system is configured to:
a) determine reflection points during a movement of the vehicle, the reflection points representing locations at which a signal of the ultrasonic sensor was reflected;
b) combine the reflection points into contiguous, linearly extending wall sections, wherein each of the wall sections have two ends;
c) determine whether an end of each of the wall sections is open or closed, the end of each wall section being considered to be closed when the reflection points abutting the end follow a non-linear progression, or when, during further movement of the vehicle, no further reflection points are combined with the end of the wall section, and the end otherwise being considered to be open;
d) extrapolate a progression of each the wall sections following each open end;
e) ascertain virtual collision points between the vehicle and the extrapolated progressions of the wall sections; and
f) initiate a brake intervention based on a collision with at least one of the virtual collision points being imminent.

20. A vehicle, comprising:
a driver assistance system for avoiding a collision of a vehicle with an obstacle, the driver assistance system including:
at least one ultrasonic sensor for determining a distance between the vehicle and an obstacle in surroundings of vehicle;
wherein the driver assistance system is configured to:
a) determine reflection points during a movement of the vehicle, the reflection points representing locations at which a signal of the ultrasonic sensor was reflected;
b) combine the reflection points into contiguous, linearly extending wall sections, wherein each of the wall sections have two ends;
c) determine whether an end of each of the wall sections is open or closed, the end of each wall section being considered to be closed when the reflection points abutting the end follow a non-linear progression, or when, during further movement of the vehicle, no further reflection points are combined with the end of the wall section, and the end otherwise being considered to be open;
d) extrapolate a progression of each the wall sections following each open end;
e) ascertain virtual collision points between the vehicle and the extrapolated progressions of the wall sections; and
f) initiate a brake intervention based on a collision with at least one of the virtual collision points being imminent.
